(19) United States
(12) Patent Application Publication
(10) Pub. No.: US 2020/0145486 A1
(43) Pub. Date: May 7, 2020

(54) COMPUTER NETWORK WITH A FIRST AND A SECOND SYNCHRONIZING SIGNAL TRANSMITTER

(71) Applicant: dSPACE digital signal processing and control engineering GmbH, Paderborn (DE)

(72) Inventors: Peter AREND, Paderborn (DE); Heiko KALTE, Paderborn (DE); Dominik LUBELEY, Paderborn (DE); Jochen SAUER, Paderborn (DE)

(73) Assignee: dSPACE digital signal processing and control engineering GmbH, Paderborn (DE)

(21) Appl. No.: 16/674,620

(22) Filed: Nov. 5, 2019

(30) Foreign Application Priority Data
Nov. 6, 2018 (DE) 10 2018 127 602.8

(51) Int. Cl. H04L 29/08; H04L 7/04; H04L 12/26

(52) U.S. Cl. CPC H04L 67/1095; H04L 43/0858; H04L 7/042

(57) ABSTRACT

Computer network having a plurality of clocks that are synchronized with one another, that are distributed among multiple participants in the computer network, and from which a global system time of the computer network can be read out. The computer network includes a first synchronizing signal transmitter for a first synchronizing signal and a second synchronizing signal transmitter for a second synchronizing signal, and every participant can be equipped to synchronize the value of a locally stored variable quantity with a global value on the basis of the first synchronizing signal or the second synchronizing signal, and in doing so to take into account a time lag of the synchronizing signal.

This nonprovisional application claims priority under 35 U.S.C. § 119(a) to German Patent Application No. 10 2018 127 602.8, which was filed in Germany on Nov. 6, 2018, and which is herein incorporated by reference.

### BACKGROUND OF THE INVENTION

### Field of the Invention

The present invention relates to the synchronization of variable quantities between participants in a computer network.

### Description of the Background Art

A computer network can be understood to mean a group of autonomous computer systems that are each equipped to process digitally stored data and that are equipped in the aggregate to exchange data with one another.

It is often necessary to synchronize a variable quantity, which is to say a quantity that varies over time, between multiple participants in a computer network. An ideal synchronization ensures that the variable quantity has a uniform value at every point in time on all participants on which it is locally stored. One problem in this context is the latency of the synchronizing signal that specifies the value of the variable quantity, which signal generally does not reach all participants at the same time because of the finite signal speed.

Methods are known from the prior art for improving the quality of the synchronization by taking into account the time lag resulting from the latency. From DE 10 2005 039 450 B4, which is incorporated herein by reference, a method is known for achieving an ideal synchronization in the aforementioned sense. To this end, a system time that is in the future is communicated to the participants with the synchronizing signal, at which time each participant matches the variable quantity to the specification from the synchronizing signal. The system time that is in the future is chosen such that the synchronizing signal reaches all participants before the time stored in the synchronizing signal for matching of the variable quantity occurs.

This method guarantees nearly perfect synchronism between the participants, although at the price of a delayed matching by individual participants to the specification of the synchronizing signal, because all participants wait to make the adjustment until the synchronizing signal has propagated throughout the entire computer network. During the time lag, which is to say the period between transmission of the synchronizing signal by a synchronizing signal transmitter and the matching of the variable quantity to the specification of the synchronizing signal by the participants, the local instances of the variable quantity stored on the participants drift away from the value of the variable quantity stored on the synchronizing signal transmitter. It is therefore advantageous for the quality of the synchronization of a variable quantity to minimize the time lag. Minimization of the time lag also makes it possible to increase the transmission frequency of the synchronizing signal in order to achieve a more precise quality of reproduction of the variable quantity.

### SUMMARY OF THE INVENTION

It is therefore an object of the present invention is to improve the synchronization of variable quantities in a computer network.

The subject matter of the invention is a computer network having a multiplicity of clocks that are synchronized with one another, that are distributed among multiple participants in the computer network, and from which a global system time of the computer network can be read out. Methods for synchronization of clocks in order to provide a uniform system time are known from the prior art and are not explained in detail in the present description.

The computer network includes a first synchronizing signal transmitter, which is equipped to issue a first synchronizing signal that is accessible to all participants, and a second synchronizing signal transmitter, which is equipped to issue a second synchronizing signal that is accessible to all participants. Every participant can be equipped to synchronize the value of a locally stored first variable quantity with a global value of the first variable quantity specified on the computer network by utilization of the global system time and of the first synchronizing signal. Every participant can also be equipped to synchronize the value of a locally stored second variable quantity with a global value of the second variable quantity specified on the computer network by utilization of the global system time and of the second synchronizing signal. In addition, every participant is equipped to take into account a time lag of the synchronizing signal when utilizing a synchronizing signal for the synchronization of a variable quantity.

In order to minimize the time lag of the first synchronizing signal, the computer network is equipped to assign all participants equipped for utilizing the first synchronizing signal to the first synchronizing signal transmitter to measure, for each participant assigned to the first synchronizing signal transmitter, the propagation time of the first synchronizing signal until it reaches the respective participant, and to define the greatest measured propagation time of the first synchronizing signal as the time lag of the first synchronizing signal.

In the same manner, in order to minimize the time lag of the second synchronizing signal, the computer network is equipped to assign all participants equipped for utilizing the second synchronizing signal to the second synchronizing signal transmitter to measure, for each participant assigned to the second synchronizing signal transmitter, the propagation time of the second synchronizing signal until it reaches the respective participant, and to define the greatest measured propagation time of the second synchronizing signal as the time lag of the second synchronizing signal.

Within the scope of the present patent specification and patent claims, participants in the computer network according to the invention are understood exclusively as components that are integrated into the computer network and can be equipped for reading in and utilizing a synchronizing signal. This does not preclude the computer network from including additional components that cannot be equipped to analyze and utilize a synchronizing signal.

Depending on the number of synchronizing signals present in a computer network, the computer network can be equipped to assign participants of the computer network to an arbitrary additional synchronizing signal transmitter, to measure, for each participant assigned to a respective synchronizing signal transmitter, the propagation time of the synchronizing signal transmitted by the respective synchronizing signal transmitter until it reaches the respective participant, and to define the greatest measured propagation time of the respective synchronizing signal as the time lag of the synchronizing signal.

Accordingly, the invention is based on the idea, in a computer network with at least two different synchronizing signals, of grouping the participants of the computer network and assigning to each synchronizing signal, as a group, the participants of the computer network that read in the respective synchronizing signal. The measurement of the maximum propagation time of each synchronizing signal then takes place not with reference to the entire computer network, but instead only within the group of participants that are assigned to the synchronizing signal in each case. The time lag of the individual synchronizing signals is reduced in this way and the quality of the synchronization is improved as a result.

Advantageously a dedicated synchronizing signal receiver is placed on each participant, or at least on each participant equipped for reading in a synchronizing signal, and a variable quantity that is readable by the respective participant on which the synchronizing signal receiver is placed and that is intended for synchronization with a global value is stored locally on each synchronizing signal receiver. In this embodiment, each synchronizing signal receiver is equipped to read in the global system time and a synchronizing signal in order to synchronize the value of the locally stored variable quantity with a global value. In this design, each synchronizing signal receiver is equipped to read in configuration data and to read in a synchronizing signal, for example the first synchronizing signal or the second synchronizing signal, as a function of the configuration data in order to synchronize the locally stored variable quantity with a global value on the basis of the read-in synchronizing signal, for example the global value of the first variable quantity or the second variable quantity.

A computer network according to the invention can also be constructed such that a synchronizing signal is utilized exclusively by the participant on which the synchronizing signal transmitter issuing the said synchronizing signal is placed. In this case it can be advantageous to dispense with the measurement of the propagation time of the said synchronizing signal and to define its time lag as zero.

The first synchronizing signal transmitter and the second synchronizing signal transmitter can also provide a single global value of a variable quantity with different propagation times. Consequently, in this embodiment a common global value is specified on the computer network for the first variable quantity and the second variable quantity. For example, the second synchronizing signal may be utilized only by a single participant that is located in the immediate vicinity of the second synchronizing signal transmitter, so that the synchronization of the said participant with the second synchronizing signal is of especially high quality, while all other participants utilize the first synchronizing signal.

In an embodiment, the first synchronizing signal transmitter and the second synchronizing signal transmitter read in the common global value from a common source, for example a sensor or a memory address. In an embodiment, the second variable quantity on the second synchronizing signal transmitter is synchronized with the first variable quantity on the first synchronizing signal transmitter.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a test stand for an automotive control unit, which includes a computer network according to the invention;

FIG. 2 shows a detailed representation of the computer network; and

FIG. 3 shows the computer network in an alternative structure, equipped for provision of a single global value of a variable quantity through two synchronizing signals.

### DETAILED DESCRIPTION

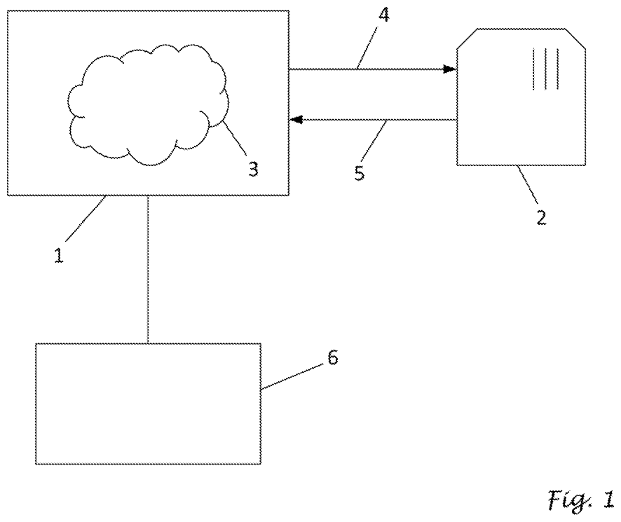

The illustration in FIG. 1 shows a test stand for an automotive control unit 2, comprising a computer network 1 and a control computer 6 that is connected to the computer network 1. A simulation model 3 that emulates an environment of the control unit 2 in hard real time runs on the computer network 1. The simulation model 3 includes, in particular, a simulation of a vehicle in which the control unit 2 is installed. The computer network 1 is equipped to transmit stimulus data 4 generated by means of the simulation model 3, for example simulated sensor data, to the control unit 2. The computer network is also equipped to read in response data 5 provided by the control unit 2, for example control data for actuators, and to take the data into account when computing the model state of the simulation model 3 in the next time step.

Stored on the control computer 6 is configuration software for programming and configuration of the computer network 1 as well as operating software for monitoring and controlling the simulation model 3. The configuration software is equipped, in particular, to generate configuration data that can be read in by synchronizing signal receivers 22A, . . . , 22I in the computer network 1.

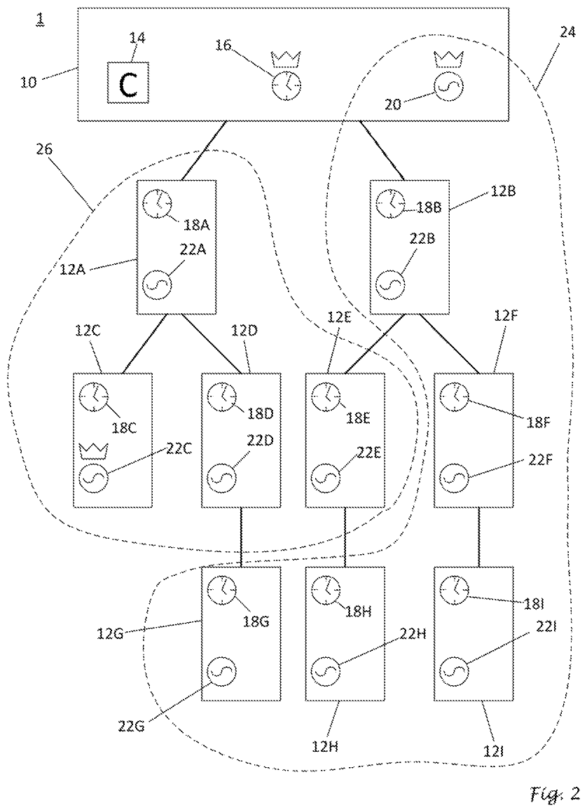

The illustration in FIG. 2 shows a detail view of the computer network 1. The computer network 1 is constructed in a tree topology. The topmost node is composed of a main computing unit 10, which includes a central processing unit 14 on which the simulation model 3 is partially or completely stored, a master clock 16, and a first master angle clock 20. The other nodes are composed of a number of additional participants 12A, . . . , 12I of the computer network 1. At least some of the participants 12A, . . . , 12I are I/O modules for data exchange of the computer network 1 with a peripheral, for example with the control unit 2 or with actual loads. To reduce the load on the central processing unit 14, at least some of the participants 12A, . . . , 12I can include their own processors, which are charged with the preprocessing of input data or the post-processing of output data, for example. Other participants 12A, . . . , 12I can include FPGAs, which are charged with the computation of individual model components of the simulation model 3 in place of the central processing unit 14.

The master clock 16 serves to provide a system time that is valid on the entire computer network 1, which the master clock 16 provides on the entire computer network 1 in the form of a time signal. Placed on each participant 12A, . . . , 12I is a slave clock 18A, . . . , 18I, each of which is equipped to read in the time signal and to synchronize itself with the master clock 16 on the basis of the time signal. Every participant 12A, . . . , 12I is equipped to read in the system time from its own slave clock 18A, . . . , 18I as needed.

The first master angle clock 20 serves to provide a global first angular position, which is to say one that is valid on the entire computer network 1. The first angular position can be, for example, an angle of rotation of a virtual shaft in the transmission of the vehicle simulated within the simulation model 3 or an angular position of the rotating electric field of an electric motor of the same vehicle. Some of the participants 12A, . . . , 12I need the first angular position as an input value for locally stored program routines. The first master angle clock 20 is therefore equipped as a first synchronizing signal transmitter in order to issue a first synchronizing signal that is accessible to all participants 12A, . . . , 12I. The first angular position can be read out or derived from the first synchronizing signal. The first synchronizing signal can transport a value for the first angular position and/or a value for the rate of change (angular velocity) of the first angular position, for example.

Placed on the participants 12A, . . . , 12I are additional angle clocks 22A, . . . , 22I, which, with the exception of the angle clock 22C, are configured as slave angle clocks, which is to say as synchronizing signal receivers. A local instance of an angular position is stored locally on each slave angle clock as a variable quantity, and each slave angle clock can be equipped on the basis of the configuration software to read out the system time from the local slave clock 18A, . . . , 18I, to read out a value from the first synchronizing signal, and to synchronize the value of the local instance of the angular position with the global value of the first angular position on the basis of the system time and the first synchronizing signal.

An additional angle clock on the participant 12C is equipped as a second master angle clock 22C, which is to say as a second synchronizing signal transmitter, and serves to provide a global second angular position by issuing a second synchronizing signal that is accessible to all participants 10, 12A, . . . , 12I. Each slave angle clock can be equipped on the basis of the configuration software to read out the system time from the local slave clock 18A, . . . , 18I, to read out a value from the second synchronizing signal, and to synchronize the value of the local instance of the angular position with the global value of the second angular position on the basis of the system time and the second synchronizing signal.

The slave angle clocks 22A, 22B, 22D, . . . , 22I are equipped to take into account a time lag of the first synchronizing signal during synchronization with the global value of the first angular position and to take into account a time lag of the second synchronizing signal during synchronization with the global value of the second angular position. An accounting of this nature can be implemented, for example, such that a master angle clock 20, 22C stores in the synchronizing signal a system time that is in the future when the synchronizing signal is transmitted. In this embodiment of the invention, the time interval between the current system time and the system time stored in the synchronizing signal is at least as great as the time interval until the synchronizing signal is received by all participants 12A, . . . , 12I whose angle clocks 22A, . . . , 22I are equipped to utilize the relevant synchronizing signal. The slave angle clocks are equipped to delay synchronizing the local instance of the angular position until the system time that can be read from the local slave clock 18A, . . . , 18I matches the system time stored in the synchronizing signal.

In order to minimize the time lag of the first synchronizing signal and of the second synchronizing signal, the computer network is equipped to combine all participants 12A, . . . , 12I whose angle clocks 22A, . . . , 22I are equipped to utilize the first synchronizing signal into a first group 24 and to assign all participants of the first group 24 to the first master angle clock 20, and to combine all participants 12A, . . . , 12I whose slave angle clocks are equipped to utilize the second synchronizing signal into a second group 26 and to assign all participants of the second group 26 to the second master angle clock 22C.

Every master angle clock 20, 22C measures the propagation times of its respective synchronizing signal to each of the participants assigned to it and defines the greatest measured propagation time as the time lag of the synchronizing signal. A method known from the prior art for measuring signal propagation times can be used for this purpose, for example the transmission of a test data packet with a time stamp by a master angle clock and the comparison of the current system time with the time stamp by a slave angle clock.

By way of example, the first master angle clock 20 measures five propagation times of the first synchronizing signal, namely the propagation times to the participants 12B, 12F, 12G, 12H, and 12I belonging to the first group 24. The first master angle clock 20 determines the greatest propagation time in the first group 24 from among the propagation times measured by the first master angle clock 20 and defines the greatest propagation time in the first group as the time lag of the first synchronizing signal. This means that the first master angle clock 20 selects the system time stored in the first synchronizing signal such that the time interval between the transmission of the first synchronizing signal by the first master angle clock 20 and the system time stored in the first synchronizing signal is at least as great as the defined time lag of the first synchronizing signal.

Analogously, the second master angle clock 22C measures three propagation times of the second synchronizing signal, namely the propagation times to the participants 12A, 12D, and 12E belonging to the second group 26. The second master angle clock 22C determines the greatest propagation time in the second group 26 from among the propagation times measured by the second master angle clock 22C and defines the greatest propagation time in the second group 26 as the time lag of the second synchronizing signal. The second master angle clock 22C thus chooses the system time stored in the second synchronizing signal such that the time interval between the transmission of the second synchronizing signal by the second master angle clock 22C and the system time stored in the second synchronizing signal is at least as great as the assumed time lag of the second synchronizing signal.

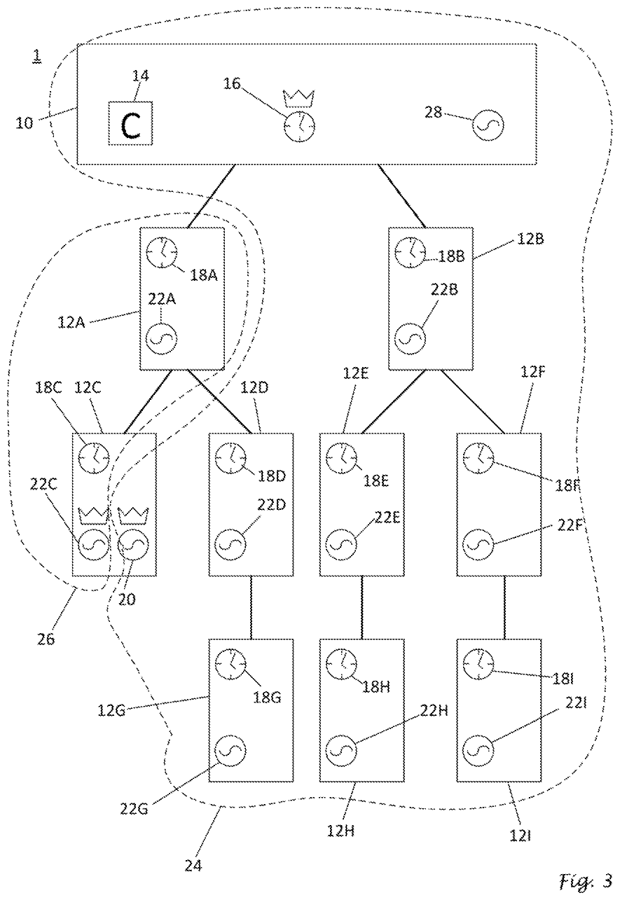

The illustration in FIG. 3 shows an alternative structure of the computer network 1 and illustrates an example for the provision of a common global value by means of two synchronizing signals. Placed on the participant 12C are two angle clocks, which are equipped as first master angle clock 20 and as second master angle clock 22C. The angle clock 28 placed on the main computing unit 10 is equipped as a slave angle clock.

In the configuration shown, all participants 12A, . . . , 12I, including the main computing unit 10, are equipped to utilize a single angular position provided in parallel by the first master angle clock 20 and the second master angle clock 22C, but the participant 12A places especially high demands on the quality of the synchronization of its slave angle clock 22A. For this reason, the participant 12A is located in the immediate vicinity of the second master angle clock 22C, and the second group 26 includes only the participant 12A as participants equipped to utilize the second synchronizing signal. All other participants 12B, 12D, . . . , 12I, with the exception of the participant 12C, are combined into the first group 24 with the main computing unit 10, and all participants in the first group 24 are equipped to utilize the first synchronizing signal.

For the first angular position and the second angular position, a common global value is specified on the computer network 1. The first master angle clock 20 reads in the global value from a source and stores it locally as the first variable quantity. The second master angle clock 22C reads in the global value from the same source and stores it locally as the second variable quantity. The source can be, for example, a memory address at which an angular position specified by the simulation model 3 is stored, or an angle sensor located on a shaft of a transmission.

In this way, all participants 12A, 12B, 12D, . . . , 12I equipped to utilize a synchronizing signal, including the main computing unit 10, in effect use this same angular position, because the same global value is specified for the first angular position and the second angular position. However, the participant 12A receives the angular position with an especially small time lag by means of the second synchronizing signal. The participants 12B, 12D, . . . , 12I of the first group 24 receive the angular position with a larger time lag by means of the first synchronizing signal.

For example, the first master angle clock 20 and the second master angle clock 22C each read in the global value of the angular position separately and independently of the other respective master angle clock. The first variable quantity on the first master angle clock 20 and the second variable quantity on the second master angle clock 22A then represent the same angular position, but are not synchronized with one another and therefore need not be identical at every point in time. Differences can arise due to different update frequencies of the first variable quantity on the first master angle clock 20 and the second variable quantity on the second master angle clock 22C, for example. The second master angle clock 22C can be equipped to issue the second synchronizing signal at a different, in particular higher, frequency than the first master angle clock 20 issues the first synchronizing signal.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A computer network comprising:
a plurality of clocks that are synchronized with one another and that are distributed among multiple participants in the computer network, and from which a global system time of the computer network is read out;
a first synchronizing signal transmitter configured to issue a first synchronizing signal that is accessible to all participants; and
a second synchronizing signal transmitter configured to issue a second synchronizing signal that is accessible to all participants,
wherein at least one participant synchronizes a value of a locally stored first variable quantity with a global value of the first variable quantity specified on the computer network by utilization of the global system time and of the first synchronizing signal,
wherein at least one participant synchronizes a value of a locally stored second variable quantity with a global value of the second variable quantity specified on the computer network by utilization of the global system time and of the second synchronizing signal,
wherein at least one participant takes into account a time lag of the synchronizing signal when utilizing a synchronizing signal for the synchronization of a variable quantity,
wherein the computer network assigns the participant for utilizing the first synchronizing signal to the first synchronizing signal transmitter to measure, for each participant assigned to the first synchronizing signal transmitter, the propagation time of the first synchronizing signal until it reaches the respective participant, and to define a greatest measured propagation time of the first synchronizing signal as the time lag of the first synchronizing signal, and
wherein the computer network assigns the participant utilizing the second synchronizing signal to the second synchronizing signal transmitter to measure, for each participant assigned to the second synchronizing signal transmitter, the propagation time of the second synchronizing signal until it reaches the respective participant, and to define a greatest measured propagation time of the second synchronizing signal as the time lag of the second synchronizing signal.

2. The computer network according to claim 1, wherein a synchronizing signal receiver is placed on each participant, wherein a variable quantity that is readable by the respective participant and is intended for synchronization with a global value is stored locally on each synchronizing signal receiver, wherein each synchronizing signal receiver is equipped to read in the global system time and a synchronizing signal in order to synchronize the value of the locally stored variable quantity with a global value, and wherein each synchronizing signal receiver is equipped to read in configuration data, and to read in the first synchronizing signal or the second synchronizing signal as a function of the configuration data.

3. The computer network according to claim 1, wherein the computer network specifies a common global value for the first variable quantity and for the second variable quantity or a global value of the first variable quantity and a global value of the second variable quantity from a common source.
